(19) United States
(12) Patent Application Publication
(10) Pub. No.: US 2017/0318785 A1
(43) Pub. Date: Nov. 9, 2017

(54) Claw Shearing Device With Detachable Shearing Element and Method of Using Same

(71) Applicant: Pet Product Innovations, LLC, Des Plaines, IL (US)

(72) Inventors: David J. Levy, Des Plaines, IL (US); Levi J. Perea, JR., Des Plaines, IL (US); Joseph Ek, Fort Wayne, IN (US)

(73) Assignee: Pet Product Innovations, LLC, Des Plaines, IL (US)

(21) Appl. No.: 15/412,520

(22) Filed: Jan. 23, 2017

Related U.S. Application Data
(63) Continuation of application No. PCT/US2015/041697, filed on Jul. 23, 2015.
(60) Provisional application No. 62/027,907, filed on Jul. 23, 2014.

(51) Int. Cl. A01K 17/00; A45D 29/02

(52) U.S. Cl. CPC A01K 17/00; A45D 29/02

(57) ABSTRACT

A claw shearing device including a first member and a second member, each having a connecting portion, a handle portion, and a plurality of grooves formed at an end opposite the handle portion. A fastener is provided to pivotably attach the first member to the second member. The device includes first and second detachable shearing elements, configured to be releasably engageable with the plurality of grooves of the first and second members, respectively. The first and the second detachable shearing elements are configured to form an orifice for the insertion of a claw of a pet or an animal, where the maximum diameter of the orifice is no greater than the maximum diameter of an animal's claw as measured from a tip of the claw to the beginning of a quick that is closest to the tip. The device is configured to bring together the shearing elements to cut the claw of the pet or animal at a predetermined length.

### BACKGROUND

The present disclosure generally relates to claw and/or nail shearing devices for animals, such as pets, which can be used to shear, cut, and/or trim the claws and/or nails of said animals. More specifically, the present disclosure is related to claw and/or nail shearing devices which have detachable shearing elements.

A common task associated with the care of claw-bearing animals involves the shearing, or cutting and/or trimming, of the animals' claws and/or nails. The claws or nails of animals and pets, such as those of dogs, cats, rabbits, and other mammals, contain a hard outer shell and a soft cuticle located toward the center of the nail. The cuticle is often referred to as the “quick” or “kwick” of the pet's nail (hereinafter “quick”). The cuticle or quick contains a nerve and a blood vessel. Accidentally cutting the quick of the nail can cause excessive bleeding and varying sensations of pain, trauma, and severe discomfort for the animal.

Therefore, it is vital for those who are shearing the claws of animals to take special care to avoid cutting through the quick of the animal's claws or nails while shearing. Unfortunately, it is not uncommon for even the most seasoned pet owner or animal handler to accidentally or inadvertently cut the quick of the animal's claw or nail, thereby causing bleeding, pain, and sometimes severe trauma for the animal or pet.

The likelihood of this occurring is only exacerbated by the fact that different animals have overall different sizes and diameters of claws and/or nails. As such, the location of an animal's quick on its claw will vary depending upon the size of the claw, which in turn will vary depending upon the type of animal (e.g., kittens versus large dogs versus Flemish Giant rabbits all have different size claws). As a result, it can be strenuous and problematic for an individual to shear the claws of several different types of animals, all the while attempting to avoid cutting through the quick.

### SUMMARY

The present invention relates to devices for shearing and/or trimming and/or cutting the claws and/or nails of animals having a detachable blade, and methods for using same. As used herein, it will be appreciated by one of ordinary skill that the term “shearing” can be used interchangeably with the terms “trimming” and “cutting,” particularly with reference to an animal's claws and/or nails, unless expressly indicated to the contrary. The terms “shearing,” “cutting” and “trimming” will also be understood herein to refer to an act of breaking off or causing to break off a portion of the object being sheared, cut, and/or trimmed (such as the claws and/or nails of an animal).

As used herein, it will be understood by one of ordinary skill in the art that the terms “claw” and “nail,” in relation to the claws and nails of an animal, such as a pet, can be used interchangeably.

According to an embodiment of the present invention, a claw shearing device is provided. The claw shearing device includes a first member and a second member. Both the first member and the second member have a connecting portion, a handle portion, and a plurality of grooves formed at an end opposite the handle portion. A fastener is provided, configured to pivotably attach the connecting portion of the first member to the connecting portion of the second member. The claw shearing device also includes a first detachable shearing element and a second detachable shearing element. The first and the second detachable shearing elements each include a cutting edge, and are configured to be releaseably engageable with the plurality of grooves of the first member and the plurality of grooves of the second member, respectively. The first and the second detachable shearing elements are configured to form an orifice for the insertion of a claw of an animal.

In a further embodiment to any of the previous embodiments, the first and second detachable shearing elements of the claw shearing devices each include an outer pressing surface.

In a further embodiment to any of the previous embodiments, the first and second detachable shearing elements of the claw shearing device each include a plurality of protrusions configured to be releasably engageable with the plurality of grooves of the first and second member, respectively.

In a further embodiment to any of the previous embodiments, the claw shearing device includes a spring attached at one end to the handle portion of the first member and at an opposite end to the handle portion of the second member.

In a further embodiment to any of the previous embodiments, the claw shearing device includes a safety mechanism configured to prevent an accidental removal of any one of the first and second detachable shearing elements.

In a further embodiment to any of the previous embodiments, the claw shearing device includes a locking mechanism configured to prevent the device from moving between an open state in which the orifice is open, and a closed state in which the first and second detachable shearing elements are superimposed on each other from a shearing motion.

In a further embodiment to any of the previous embodiments, the orifice of the claw shearing device has a diameter that is no greater than a maximum diameter of the animal's claw as measured from a tip of the claw to the beginning of a quick that is closest to the tip.

In a further embodiment to any of the previous embodiments, the claw shearing device includes a release mechanism configured to release the first and second detachable shearing elements from the device.

According to another embodiment of the present invention, a method is provided of using a device for shearing an animal's claw. The method includes providing a claw shearing device having a first detachable shearing element and a second detachable shearing element. The first and the second detachable shearing elements each have a cutting edge, and the first and the second detachable shearing elements are configured to form an orifice for the insertion of a claw of an animal. The method includes determining a maximum diameter of the animal's claw as measured from a tip of the claw to the beginning of the quick of the animal that is closest to the tip. The first and the second detachable shearing elements are selected such that a maximum diameter of the formed orifice is less than the above-determined maximum diameter of the animal's claw as measured from a tip of the claw to the beginning of the quick of the animal that is closest to the tip. The selected first and second detachable shearing elements are attached to the device. The animal's claw is inserted into the orifice of the device, and the animal's claw is sheared by bringing together the detachable shearing elements of the device.

As used herein “substantially”, “relatively”, “generally”, “about”, and “approximately” are relative modifiers intended to indicate permissible variation from the characteristic so modified. They are not intended to be limited to the absolute value or characteristic which it modifies but rather approaching or approximating such a physical or functional characteristic.

In this detailed description, references to “one embodiment”, “an embodiment”, or “in embodiments” mean that the feature being referred to is included in at least one embodiment of the invention. Moreover, separate references to “one embodiment”, “an embodiment”, or “embodiments” do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

### BRIEF DESCRIPTION OF THE SEVERAL VIEWS OF THE DRAWINGS

FIG. 1 is an illustration of a claw shearing device according to one embodiment of the present invention.

FIG. 2 is another view of a claw shearing device according to one embodiment of the present invention.

FIG. 3 is an illustration of a detachable shearing element according to one embodiment of the present invention.

Given the following enabling description of the drawings, the devices and methods should become evident to a person of ordinary skill in the art.

### DETAILED DESCRIPTION

According to the devices of the present invention, it is possible to shear, cut or trim the claws of several different types, species, and sizes of animals without cutting the quick, all while using the same overall device. In particular, devices of the present disclosure include detachable shearing elements. As a result, the user can attach, detach, and re-attach various shearing elements configured to match different types, species, and sizes of animals having different size claws (e.g., kittens, large dogs, rabbits, etc.). The detachable shearing elements of devices of the present disclosure are configured to form an orifice. During use, the claw of the animal to be sheared is inserted into the orifice of the device.

The detachable shearing elements should be selected such that the diameter of the orifice that is formed is no greater than the diameter of the claw of the animal as measured from the tip of the claw to the beginning of the quick closest to the tip of the claw. This ensures that the quick of the animal is not cut during shearing. Since different animals have different size claws, embodiments of the present invention allow for one device to be used to shear or cut the claws of multiple different types, species, and/or sizes of animals, simply by selecting and attaching, detaching and re-attaching properly sized detachable shearing elements. This substantially reduces, and in some instances eliminates altogether, the possibility of cutting the quick of the animal's claw while shearing the claw, for multiple different types, species, and/or sizes of animals with a single device.

Often it is the case that in the general care and handling of animals, it is necessary to sterilize and clean equipment. As such, the present invention allows for ease of removal of the shearing elements so that the portion of the device that comes into contact with the claw of the animal(s) can be routinely sterilized and/or cleaned. Embodiments of the present invention also allow for ease of removal of the shearing elements for routine maintenance, such as sharpening of the cutting edges or surfaces and other treatment, without potentially damaging or affecting the remainder of the device.

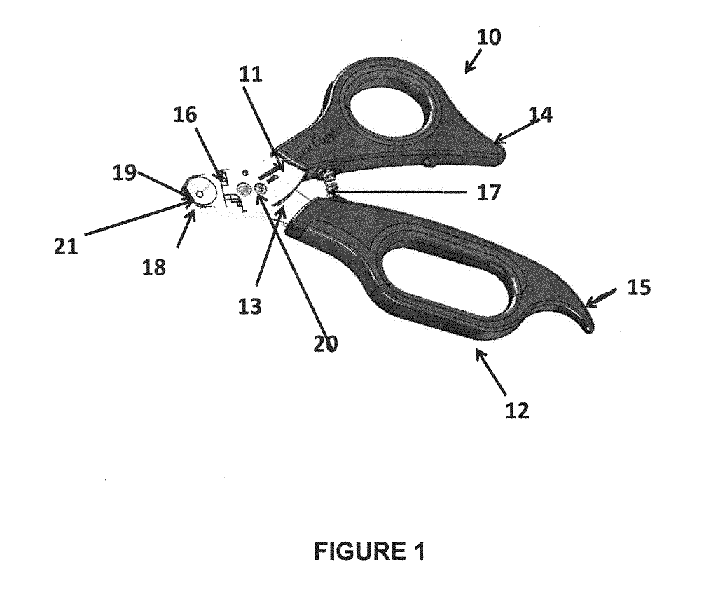

With reference now to FIG. 1, a claw shearing device is illustrated. The claw shearing device includes a first member 10 and a second member 12. The first member 10 can include a connecting portion 11, and a handle portion 14, and a plurality of grooves 16. The second member 12 can include a connecting portion 13, and a handle portion 15, and a plurality of grooves (not illustrated).

The configuration of the first and the second member is not particularly limited. For example, the members can be configured to resemble a scissor style claw shearing device. Alternatively, the members can be configured to resemble a guillotine style claw shearing device, a shear style claw shearing device, and/or a plier style claw shearing device. Moreover, regardless of whether the shearing device of the present invention is configured to resemble a scissor style, a guillotine style, a shear style and/or a plier style shearing device, it will be appreciated that the relative size of the shearing device can be modified to a small, medium, and/or large device (e.g., a small scissor-style shearing device, a medium guillotine-style shearing device, and the like).

In some embodiments, the handle portion can include an additional gripping layer covering or surrounding the handle portion, as shown in FIG. 1.

In embodiments, the gripping layer can be made of any resilient, durable and non-toxic rubber or plastic material, such as natural and synthetic rubbers or a blend of synthetic rubbers, nylons, polyesters, and vinyl plastics. In embodiments, illustrative examples of suitable materials that the first and second portions can be made of include, but are not limited to, neoprene plastic, isoprene, styrene-butadiene rubber, butadiene, ethylene-propylene, butyl, chloroprene, nitrile rubber, polyurethane, polycarbonate, acrylonitrile butadiene styrene, and mixtures thereof.

As shown in FIG. 1, the handle portion 14 of the first member 10 is distal in relation to the connecting portion 11, and the plurality of grooves 16 of the first member 10 is proximate in relation to the connecting portion 11. The same can be said for the connecting portion 13, the plurality of grooves, and the handle portion 15 of the second member 12.

The shearing device can also include a fastener 20. The fastener 20 can be configured to pivotably attach the connecting portion 11 of the first member 10 to the connecting portion 13 of the second member 12. Suitable fasteners 20 include, but are not limited to, nuts and bolts, screws, and/or rivets. The fastener 20 is configured to attach the connecting portions of the first and second members 10, 12 of the shearing device such that the connecting portion 11 of the first member 10 and the connecting portion 13 of the second member 12 are configured to pivotably engage by passing, in part, on top of each other.

The shearing device shown in FIG. 1 shows the device in an open position, with the connecting portion 11 of the first member 10 in part, on top or overlapping the connecting portion 13 of the second member 12. In the open position, an animal's claw can be inserted into the orifice of the device, for shearing.

The first member 10 and the second member 12 can each also include a plurality of grooves 16 (not illustrated with regard to the second member 12). The plurality of grooves can be configured to be releasably engageable with a first detachable shearing element 18 and a second detachable shearing element 19, said first and second detachable shearing elements 18, 19 corresponding to the first and the second members, 10, 12, respectively.

In embodiments of the present invention, the detachable shearing elements, 18, 19, can be configured to form an orifice 21 for the insertion of a claw or a nail of an animal or a pet for shearing. For example, the shearing device of FIG. 1 can be configured to bring together the first and second members to shear or cut the claw or nail of a pet at a predetermined length. During operation, a user can hold the handle portions of the shearing elements to operate the device.

In embodiments, each of the detachable shearing elements 18, 19 can include a cutting edge. In some embodiments, at least one of the cutting edges can be a curved edge. In other embodiments, both cutting edges of the first and the second detachable shearing elements can be a convex curved edge, configured such that the cutting edges form a convex, converged orifice during operation of the device.

The shape of the orifice is not particularly limiting. In some embodiments, the shape of the orifice can be elliptical or round-like in shape, such as in a circular shape. In other embodiments, the orifice can be a diamond or other polygonal shape. In other embodiments, the orifice can have a conical shape.

In some embodiments, the cutting edges of the detachable shearing elements are cut at an inclined angle and positioned such that the facing cutting edges create a funnel-like shape tapering in the direction of the claw as the claw of the animal is inserted into the orifice of the device.

In some embodiments, the cutting edges of the detachable shearing elements are capable of producing a substantially smooth cut claw edge in a single cutting action. In embodiments, the cutting edges are capable of producing a substantially smooth cut claw edge in a single cutting action, with very little to no twisting action or twisting effort required by the user. As such, in embodiments the user is capable of achieving a substantially smooth cut claw edge in a single cutting action simply by an act of bringing the two members together to close the orifice around the inserted claw.

Generally, the diameter of the claw of an animal increases from the tip of the claw, as one approaches the beginning of the quick that is closest to the tip, and continuing in a direction toward the animal. The diameter of the claw of an animal is smallest when measured at the tip of the claw, at a point furthest away from the animal itself.

During use, the maximum diameter of an animal's claw along the length of the claw beginning at the tip of the animal's claw (furthest from the animal itself) to an endpoint of the quick of the animal's claw that is located closest to the tip of the claw is determined. Then, properly sized detachable shearing elements having a maximum diameter of a formed orifice that is less than the maximum diameter of an animal's claw along the length of the claw beginning at the tip of the animal's claw (furthest from the animal itself) to an endpoint of the quick of the animal's claw are selected and attached to the device. During use, the animal's claw is inserted into the orifice of the device. Because, by selecting properly sized detachable shearing elements, the maximum diameter and size of the orifice has been set to be less than the maximum diameter of the animal's claw that is measured from the length of the claw between the tip of the claw to the quick of the animal's claw that is closest to the claw tip, shearing or cutting the animal's claw by use of the device will not cut the quick of the animal.

Regarding the detachability of the detachable shearing elements of the present invention, although the shearing device of FIG. 1 is illustrated to have a plurality of grooves configured to be releasably engageable with the detachable shearing elements; features relating to the detachability of the detachable shearing elements of the present invention are not particularly limited.

For example, the detachable shearing elements can be configured to be releasably engageable with the plurality of grooves of the first and the second members, respectively, via a snap-fit connection. The detachable shearing elements can also be configured to be releasably engageable with the plurality of grooves of the first and the second members, respectively, via a frictional engagement. Alternatively, the detachable shearing elements can be configured to be releasably engageable with the plurality of grooves of the first and the second members, respectively, via a slidable engagement. In embodiments, the shearing elements can include a plurality of protrusions to releasably engage with the plurality of grooves of the first and second members, in any configuration as described above.

Moreover, it will be appreciated that although the claw shearing device of FIG. 1 has been described having a plurality of grooves present on the first and second members, 10, 12, any one and up to all of the detachable shearing elements can have a plurality of grooves instead of the first and second members; and the first and second members can have protrusions, as opposed to grooves, as described above.

It will also be appreciated that embodiments of the present invention can be configures to releasably engage with the detachable shearing elements via frictional engagement, snap-fit connection, and/or slidable engagement, with or without a plurality of grooves. For example, a claw shearing device can include a configuration where one groove and one protrusion interlock with one another to removably attach and detach the shearing elements to the device.

In certain embodiments, any one and up to all of the detachable shearing elements can include an outer pressing surface. As an example, a user can apply pressure to the outer pressing surface of a detachable shearing element to squeeze or compress the size of the detachable shearing element in such a way to fit within the receiving portion of the first or second member. Once the engaging portion of the detachable shearing element is engaged with the respective member, the size of the detachable shearing element returns to its original shape, thereby creating a snug fit inside the receiving portion of the first or second member.

Referring back to FIG. 1, the claw shearing device can also include a spring 17. One end of the spring 17 is attached to the handle portion 14 of the first member 10. The opposite end of the spring 17 is attached to the handle portion 15 of the second member 12. The spring 17 can provide addition tension between the first and second members 10, 12 and assist the device in returning to the open position after use (e.g., after shearing the claw of the animal).

Devices of the present invention can also include a safety mechanism configured to prevent an accidental or an unwanted removal of any one of the first and/or the second detachable shearing elements. When the safety mechanism is engaged, the detachable shearing elements cannot be removed or detached without first dis-engaging the safety mechanism.

In cases where it is desired, devices of the present invention can also include a locking mechanism configured to prevent the device from moving between an open state in which the orifice is open, and a closed state in which the first and the second detachable shearing element are superimposed on each other from a shearing motion. A user can engage the locking mechanism as needed during use and operation to prevent inadvertent, unnecessary, and/or unwanted shearing with the device.

Embodiments of the present invention can also include a release mechanism, configured to release the first and the second detachable shearing elements from the device upon attachment to the device. The release mechanism can work or be configured to operate in conjunction with the optional safety mechanism, as described above, or can be separate and apart from the safety mechanism. For example, in cases where the device includes both a safety and a release mechanism, the release mechanism can be disabled automatically when the safety mechanism is enabled. Alternatively, devices can include a release mechanism without having a safety mechanism, and vice versa.

As referenced above, it will be appreciated that devices of the present disclosure can be configured such that the first detachable shearing element and the second detachable shearing element are configured to pass relative to each other in a shearing motion to shear the claw of the animal.

Moreover, it will be appreciated by one of ordinary skill that the use of the terms, “first” and “second,” whether in relation to members, detachable shearing elements, etc., are not intended to be limiting and are simply used for labeling purposes, unless expressly stated otherwise. Therefore, it is envisioned that one of ordinary skill could apply different labels, such as A, B, C . . . 1, 2, 3, . . . x, y . . . and the like.

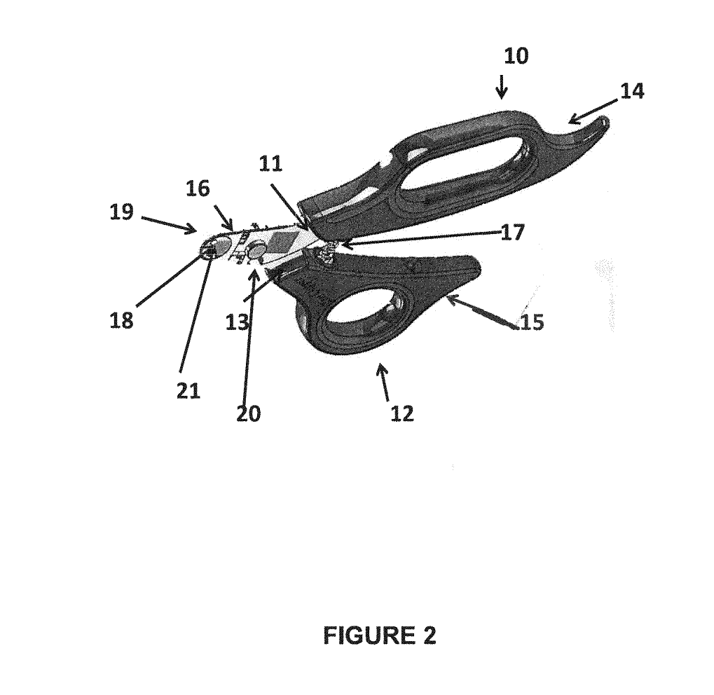

With reference to FIG. 2, another view of the claw shearing device according to one embodiment of the present invention is illustrated. The labeled components of the claw shearing device of FIG. 2 correspond to those of the claw shearing device of FIG. 1. Therefore, for sake of brevity and succinctness, the above description of the related components of FIG. 1, as they apply to FIG. 2, will not be repeated herein, and are incorporated by reference in its entirety.

During use, the claw or nail of an animal is inserted into the orifice 21. The maximum diameter or size of the orifice is limited, as described above, by selecting a detachable shearing element whose diameter is no greater than the maximum diameter of the claw of the animal as measured from the tip of the claw to the beginning of the quick closest to the tip of the claw, as noted above.

Once the claw of the animal is inserted, the detachable shearing elements of the device move to perform a cutting or a shearing action. The cutting edges of the shearing elements shear, cut, or pass through the claw of the animal, thereby shearing the claw at the desired length.

In embodiments, the cutting edges of the device produce a smooth cut claw edge in a single shearing action. In alternate embodiments, the cutting edges of the device can produce a jagged, tapered, or textured cut claw edge in a single shearing action.

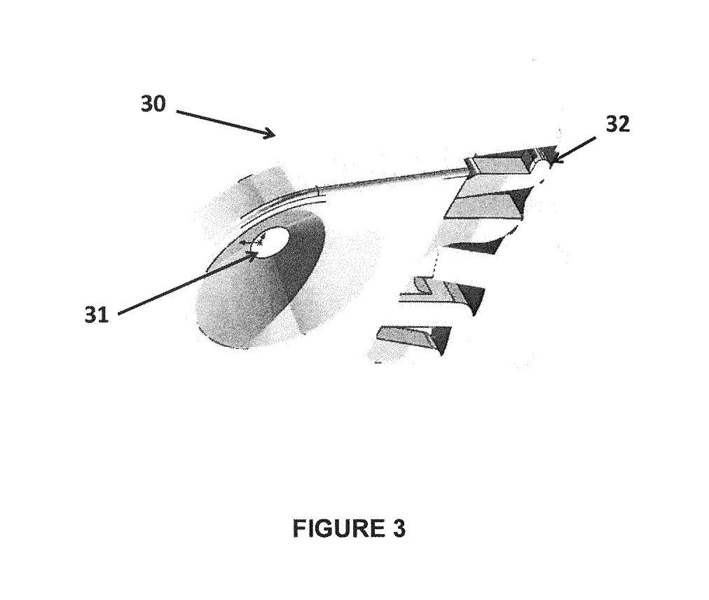

FIG. 3 provides an illustration of a detachable shearing element 30 according to one embodiment of the present invention. The detachable shearing element includes an orifice 31 into which the claw of the animal to be sheared is inserted.

A plurality of protrusions 32 is provided on the detachable shearing element 30. In embodiments, the plurality of protrusions 32 are configured to releasably engage with the plurality of grooves which can be found on the first member and the second member, as described above. Of course, embodiments of the present invention also include other ways in which the detachable shearing element can be releasably engaged with the device, as described above.

Also provided are methods for cutting or trimming the nails and/or claws of a pet utilizing nail cutting devices of the present disclosure. The maximum diameter of an animal's claw measured along the length of the claw from the tip of the animal's claw (furthest from the animal itself) to the end of the quick of the animal's claw that is closest to the tip is determined.

Then, detachable shearing elements are selected which form an orifice having a diameter that is no greater than the determined maximum diameter of the animal's claw as measured from a tip of the claw to the beginning of a quick that is closest to the tip. The selected detachable shearing elements are attached to the device. The animal's claw is inserted into the orifice of the device, and the animal's claw is sheared by bringing together the detachable shearing elements of the device.

By selecting detachable shearing elements with a diameter that is no greater than maximum diameter of the animal's claw as measured from a tip of the claw to the beginning of a quick that is closest to the tip, only a specific portion of the animal or pet's claw or nail is capable of entering the orifice to be sheared. This prevents the user of the claw cutting device from cutting the quick of the pet during use. The likelihood of the pet's quick getting cut while trimming or cutting the pet's nails is greatly decreased, thereby preventing injury, pain, and trauma and/or bleeding. In certain instances, by using devices of the present disclosure, the likelihood of the pet's quick getting cut while trimming or cutting the pet's nails is effectively eliminated.

Moreover, by having the detachable shearing elements, it is possible for users of the device to have shearing elements available for multiple species and types of animals or pets, each having different size claws. This minimizes and helps eliminate user error in terms of making sure that the proper sized orifice shearing elements are used between different animals or pets. For instance, a user can have a set of detachable shearing elements that are particularly suited and sized for smaller animals, such as kittens or toy dogs (e.g., toy poodle), which have relatively small diameter claws. The same user can also obtain a set of detachable shearing elements that are particularly suited and sized for larger animals, such as huskies, Great Newfoundland dogs, and the like, which tend to have relatively larger diameter claws.

The detachable shearing elements of the present invention also make it possible for users to remove or detach the shearing elements of the device for any one and up to all of: sanitation and cleaning purposes of the shearing elements, for health and safety reasons associated with handling animals and pets; and/or sharpening of the cutting edges of the shearing elements. In addition, in cases where the cutting edges of the shearing elements become worn or need to be replaced, devices of the present disclosure facilitate replacement of the shearing elements without having to replace the entire device.

Embodiments of the present disclosure are suitable for use by canines, canids, felines, felids, ursidae, mustelidae, and procyonidae.

As used herein, “pet” refers to an animal that is tamed or domesticated and kept for pleasure as a companion, or as a work or service animal (e.g., guide dogs and police dogs). Illustrative examples of suitable pets include pet breeds that have nails and/or claws.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of at least one other feature, integer, step, operation, element, component, and/or groups thereof

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It will also be appreciated that various presently unforeseen or unanticipated alternatives, modifications, variations or improvements therein may be subsequently made by those skilled in the art, and are also intended to be encompassed by the following claims.

1. A claw shearing device comprising:
a first member comprising a connecting portion, a handle portion, and a plurality of grooves formed at an end opposite the handle portion;
a second member comprising a connecting portion, and a plurality of grooves formed at an end opposite the handle portion;
a fastener configured to pivotably attach the connecting portion of the first member to the connecting portion of the second member; and
a first detachable shearing element comprising a cutting edge, configured to be releasably engageable with the plurality of grooves of the first member; and
a second detachable shearing element comprising a cutting edge, configured to be releasably engageable with the plurality of grooves of the second member, wherein the first and the second detachable shearing elements are configured to form an orifice for the insertion of a claw of an animal.

2. The claw shearing device of claim 1, wherein the first detachable shearing element and the second detachable shearing element each comprise an outer pressing surface.

3. The claw shearing device of claim 2, wherein the first detachable shearing element and the second detachable shearing element each comprises a plurality of protrusions configured to be releasably engageable with the plurality of grooves of the first and the second member, respectively.

4. The claw shearing device of claim 2, wherein the first and the second detachable shearing elements are configured to be releasably engageable with the plurality of grooves of the first and the second members, respectively, via a snap-fit connection.

5. The claw shearing device of claim 2, wherein the first and the second detachable shearing elements are configured to be releasably engageable with the plurality of grooves of the first and the second members, respectively, via a frictional engagement.

6. The claw shearing device of claim 2, wherein the first and the second detachable shearing elements are configured to be releasably engageable with the plurality of grooves of the first and the second members, respectively, via a slidable engagement.

7. The claw shearing device of claim 2, further comprising a spring attached at one end to the handle portion of the first member, and at the opposite end to the handle portion of the second member.

8. The claw shearing device of claim 2, further comprising a safety mechanism configured to prevent an accidental or an unwanted removal of any one of the first and/or the second detachable shearing elements.

9. The claw shearing device of claim 2, further comprising a locking mechanism configured to prevent the device from moving between an open state in which the orifice is open, and a closed state in which the first and the second detachable shearing element are superimposed on each other from a shearing motion.

10. The claw shearing device of claim 9, wherein the formed orifice has a diameter that is no greater than a maximum diameter of the animal's claw as measured from a tip of the claw to the beginning of a quick that is closest to the tip.

11. The claw shearing device of claim 10, further comprising a release mechanism configured to release the first and the second detachable shearing elements from the device.

12. The claw shearing device of claim 1, wherein the first detachable shearing element and the second detachable shearing element are configured to pass relative to each other in a shearing motion to shear the claw of the animal.

13. The claw shearing device of claim 1, wherein the orifice is a conical-shaped orifice.

14. The claw shearing device of claim 1, wherein the orifice is round or elliptical in shape.

15. The claw shearing device of claim 1, wherein the first and the second detachable shearing elements are cut at an inclined angle and positioned such that the facing cutting edges create a funnel-like shape tapering in a direction of the claw as the claw is inserted into the orifice of the device.

16. The claw shearing device of claim 1, wherein the device is configured to bring together the first and second detachable shearing elements to cut the claw of the animal at a predetermined length.

17. A method of using a device for shearing an animal's claw, the method comprising:
providing a claw shearing device comprising a first detachable shearing element and a second detachable shearing element, the first and the second detachable shearing elements each comprising a cutting edge, and wherein the first and the second detachable shearing elements are configured to form an orifice for the insertion of a claw of an animal;
determining a maximum diameter of the animal's claw as measured from a tip of the claw to the beginning of a quick that is closest to the tip;
selecting the first and the second detachable shearing elements with a maximum diameter of the formed orifice that is less than the determined maximum diameter of the animal's claw as measured from a tip of the claw to the beginning of a quick that is closest to the tip;
attaching the selected first and the selected second detachable shearing elements to the device;
inserting the animal's claw into the orifice of the device; and
shearing the animal's claw by bringing together the detachable shearing elements of the device.

18. The method of claim 17, wherein the claw shearing device further comprises a safety lock mechanism, and further comprising engaging the safety lock mechanism after attaching the selected first and the selected second detachable shearing elements to the device to prevent an accidental or an unwanted removal of any one of the first and the second detachable shearing elements.

19. The method of claim 17, wherein the attaching is performed via a frictional engagement.

20. The method of claim 17, wherein the attaching is performed via a snap-fit connection.
